(19) United States
(12) Patent Application Publication
(10) Pub. No.: US 2018/0111154 A1
(43) Pub. Date: Apr. 26, 2018

(54) NOZZLE FOR A TOOL FOR INJECTING CHEMICAL ANCHOR RESIN

(71) Applicant: Illinois Tool Works Inc., Glenview, IL (US)

(72) Inventors: Emmanuel Vallon, Portes Les Valence (FR); Pascale Grandjean, Guilherand-Granges (FR); Jérôme Couvreur, Genissieux (FR); Jean-Luc Simonin, Barcellone (FR); Guy Jaillet, La Roche de Glun (FR); Matthieu Perrier, Valence (FR); Michel Gleizolles, Saint Marcel Les Valence (FR); Ludovic Tournier, Saint Marcellin (FR)

(21) Appl. No.: 15/565,855

(22) PCT Filed: Apr. 18, 2016
(86) PCT No.: PCT/US2016/028115

§ 371 Date: Oct. 11, 2017

(30) Foreign Application Priority Data
Apr. 20, 2015 (FR) 1553527
Apr. 20, 2015 (FR) 1553528
Apr. 20, 2015 (FR) 1553529

(51) Int. Cl. B05C 17/005; A46B 13/02; B25F 5/00

(52) U.S. Cl. CPC B05C 17/00566; B05C 17/00556; A46B 2200/3013; B25F 5/003; A46B 13/02

(57) ABSTRACT

A nozzle for a tool for injecting chemical anchor resin into a hole in a wall, said nozzle comprising a body of elongate shape and comprising a longitudinal end for connection to said tool or to at least one cartridge of said tool, said body comprising at least one internal longitudinal duct for the passage of resin, wherein said nozzle comprises mechanisms for cleaning said hole by brushing and/or injection of air.

### PRIORITY CLAIM

This patent application is a national stage entry of PCT Application No. PCT/US2016/028115, which was filed on Apr. 18, 2016, which claims priority to and the benefit of French Patent Application No. 1553527, which was filed on Apr. 20, 2015; French Patent Application No. 1553528, which was filed on Apr. 20, 2015; and French Patent Application No. 1553529, which was filed on Apr. 20, 2015, the entire contents of each of which are incorporated herein by reference.

### TECHNICAL FIELD

The present disclosure relates to the field of portable tools and, in particular, those for performing tasks in or on a wall, such as a drill or a tool for injecting chemical anchor resin.

### PRIOR ART

Using a drill bit, a drill makes it possible to make a hole in a wall. A tool for injecting chemical anchor resin makes it possible to inject resin into a pre-drilled hole in a wall with a view to anchoring an element, such as a concrete rebar, to produce a wall or screed, for example.

Tools currently on the market have drawbacks, however. If they are equipped with a removable secondary grip, for example, fitting/removing the grip is relatively lengthy and complex to carry out, with the result that this grip is either kept permanently on the tool without being used or is never used and is thus removed from the tool. This grip generally comprises a first, gripping part, which has an elongate shape and is configured to be held in a user's hand, and a second part for fitting onto the tool, formed by a tightening collar. The collar is open and comprises a slot closed by a screw. If this screw is not equipped with a thumb wheel or a wing nut, fitting and tightening the grip on the tool would require the use of a screwdriver, which would render fitting/removal of the grip lengthy and complex owing, in particular, to the operation of tightening/loosening the screw. Furthermore, this type of grip is relatively expensive and has a relatively significant weight, owing to the fact that, in particular, it comprises a plurality of components.

Furthermore, when a hole of a specific length has to be drilled into a wall using a drill, it is known to equip the drill with a depth stop designed to bear against the wall. In practice, this depth stop is formed by a rectilinear rod mounted slidably in a support located on one side of the drill, in a direction parallel to the drill bit. It is possible to adjust the position of the rod relative to its support and to immobilize it in a given position using a button or a tightening screw, possibly equipped with a thumb wheel. The free end of the rod located on the side of the drill bit is designed to bear on the wall when the required drilling depth has been achieved. The position of the rod is thus adjusted such that the distance between the free ends of the rod and of the drill bit corresponds to the required drilling depth. This system is not always reliable and is thus little used, in particular because the rod may move during operation if the screw is not correctly tightened. Thus, a user tends, rather, to adopt an alternate, simpler solution consisting in attaching a piece of adhesive tape to the drill bit, in a longitudinal position designed to define the required drilling depth.

Furthermore, prior to using a tool for injecting chemical anchor resin, it is necessary to use other tools, such as that shown schematically in FIG. 1, which renders the chemical anchor operation lengthy and tedious. A first step consists in drilling a hole 10 of a given length using a drill 12 equipped with a drill bit 14. A second step consists in injecting pressurized air 16 into the hole 10 using another tool 18 connected by a flexible hose to a compressor and comprising a longitudinal fitting inserted in the hole. The injection of air into the hole makes it possible to expel dust and debris present in the hole as a result of the first, drilling step. A further step consists in cleaning the inside of the hole by brushing using the drill 12 or a drill equipped with a brush 19. The brush 19 is set in rotation and inserted into the hole 10 in order to sweep the internal cylindrical surface 20 of the hole. This brushing step is followed by a further step of injecting pressurized air 16 into the hole 10 using the tool 18, so as to remove the dust and debris detached from the walls of the hole during the brushing operation. Lastly, the step of injecting resin 22 may be performed using a tool 24 equipped with a nozzle 26 that is inserted into the hole 10. It is difficult to control the amount of resin 22 injected into the hole 10, and the operator has to inject resin over half the length of the hole located on the side opposite the tool 24 and thus leave free half the length of the hole located on the side of the tool. This prevents excess resin from oozing out of the hole when a concrete rebar is inserted into the full length of the hole. This problem is compounded by the fact that the ambient temperature influences the viscosity of the resin. When the ambient temperature is very low, the resin is relatively viscous and significant pressure has to be applied to the trigger of the injection tool, particularly when this pressure is transmitted mechanically to a resin injection piston. This significant pressure may be interpreted by an operator as being due to too great an amount of resin in the hole, which is not the case and which may therefore give rise to poor securing of the concrete rebar in the hole owing to a lack of resin.

The present disclosure proposes a simple, effective and economical solution to at least some of the aforesaid problems.

### SUMMARY OF THE INVENTION

According to a first aspect, the present disclosure proposes a nozzle for a tool for injecting chemical anchor resin into a hole in a wall, said nozzle comprising a body of elongate shape and comprising a longitudinal end for connection to said tool or to at least one cartridge of said tool, said body comprising at least one internal longitudinal duct for the passage of resin, wherein said nozzle comprises mechanisms for cleaning said hole by brushing and/or injection of air.

The present disclosure offers a clear advantage over the prior art because it combines two functions in one and the same tool, namely the injection of resin and the cleaning of the hole. In the prior art described above, the hole is cleaned using two different tools, one providing cleaning of the hole by brushing and the other providing cleaning of the hole by injection of air. The tool according to the present disclosure combines, with the function of injecting resin, at least one and preferably two type(s) of cleaning. Insofar as the tool is configured to perform cleaning of the hole by brushing, this enables the prior art tool formed by the drill and the brush to be dispensed with. Insofar as the tool is configured to perform cleaning of the hole by injection of air, this allows the prior art compressed air gun to be dispensed with. Advantageously, the tool according to the present disclosure combines both types of cleaning with the function of injecting resin, which makes it possible to dispense with the aforesaid two tools. It is thus possible to use only one single tool for implementing the last four steps shown in FIG. 1, as against three tools in the prior art. This thus represents a significant time-saving in terms of an operation for injecting resin and a significant simplification of this operation.

The nozzle according to the present disclosure may comprise one or more of the following features, taken in isolation from one another or in combination with one another:
said body comprises at least one internal longitudinal canal for the passage of air; preferably, said at least one canal is a canal for the expulsion of air (which would be injected into the hole), but provision could be made, either instead or in addition, for at least one air aspiration canal (the air would be aspirated from the hole);
said at least one canal and said at least one duct extend substantially over the entire longitudinal dimension of the nozzle;
said at least one canal may extend over a part only of the longitudinal dimension of the nozzle, in particular for a use of the nozzle in a hole of small diameter, for example less than 20 mm; said at least one canal could then open out not at the longitudinal end of the nozzle opposite its connection end but at a distance from these ends;
said at least one canal and said at least one duct open out at each of the longitudinal ends of the nozzle;
said at least one canal has a cross section of circular or parallelepipedal shape;
said body comprises a single air-passage canal through which the longitudinal axis of the nozzle passes;
said body comprises a single resin passage duct;
said at least one canal and said at least one duct are parallel;
at least one of said at least one canal and said at least one duct has a helical shape;
said body comprises at least two resin passage ducts evenly distributed about said longitudinal axis;
the nozzle comprises two resin passage ducts that are diametrically opposed with respect around to said longitudinal axis, between which said single canal extends;
each of said two ducts has a substantially semi-circular shape in transverse section;
said two ducts define between them a longitudinal space a middle part of which is occupied by said single canal and of which the two lateral parts are at least partially recessed and preferably define external longitudinal grooves of said body;
the nozzle comprises an end fitting attached to the opposite longitudinal end of the body from said connection end, this fitting comprising at least one air ejection orifice in fluidic communication with said at least one canal, and at least one resin ejection orifice in fluidic communication with said at least one duct;
the nozzle comprises mechanisms for brushing at least an internal surface of said hole;
said brushing mechanisms comprise at least one brush and, for example, a single brush;
the or each brush has a helical shape, which may extend over all or part of the longitudinal dimension of the nozzle, as is the case for a bottle brush, for example;
said brushing mechanisms comprise at least two independent external brushes;
said brushes are diametrically opposed with respect to a longitudinal axis of the body;
each of said brushes has a planar general form;
each of said brushes has a substantially radial orientation and comprises a free radially external end and an internal radial end for securing to said body;
said brushes are respectively mounted in longitudinal grooves of said body, such that those aforesaid extend between the two ducts;
said body is formed as a single component;
said fitting comprises mechanisms for brushing an internal surface of said hole; and
said fitting comprises mechanisms for rotating the air contained in the hole.

The present disclosure further relates to a tool for injecting chemical anchor resin and configured to be equipped with a nozzle as described above, wherein it comprises mechanisms for injecting resin into said at least one duct, and:
mechanisms for injecting air into said hole, and/or
mechanisms for rotating the nozzle so as to brush at least one internal surface of said hole.

The tool according to the present disclosure may comprise one or more of the following features, taken in isolation from one another or in combination with one another:
said resin injection mechanisms comprise a rotary mixer which is configured to rotate as one with said connection end of the body of the nozzle;
said resin injection mechanisms comprise a mixer that is stationary whereas the nozzle may itself rotate;
said mixer comprises a first longitudinal end for connection to a longitudinal end of said at least one canal or duct, said mixer comprising a first bore for the circulation of air, which bore opens onto said first longitudinal end so as to supply said at least one canal with air;
the mixer at an opposite longitudinal end comprises a portion for connecting to a drive member, itself connected to an output shaft of a motor or geared motor unit, said drive member comprising a second bore for the circulation of air in fluidic communication with said first bore;
said drive member comprises an external annular groove in fluidic communication with said second bore, said drive member being at least partially surrounded by a stator bushing which closes said groove and which comprises at least one substantially radial orifice opening into said groove and configured to be connected to an air outlet of a compressor incorporated into the tool, for example using a flexible hose,
the tool comprises electrical or pneumatic supply mechanisms is configured to be connected to electrical or pneumatic supply mechanisms; as an alternative, the tool might simply be a resin injection gun with no electrical or pneumatic equipment or electrical or pneumatic supply mechanisms, and
the tool comprises a pneumatic logic component, which may, for example, replace position sensors and electronic boards for controlling the tool.

The present disclosure also relates to a method for injecting chemical anchor resin into a hole in a wall using a single tool equipped with a nozzle as described above, wherein it comprises the steps consisting in:
inserting the nozzle into the hole,
injecting air into the hole using the nozzle and/or rotating the nozzle so as to use the nozzle to brush at least one internal surface of the hole,
injecting resin into the hole using the nozzle.

Provision could be made to dispense with the injection of air, particularly for cleaning holes of small diameter. The dust would then be detached from the surface of the hole by brushing and ejected through the effect of brushing itself at one and/or the other of the ends of the hole, i.e. at the bottom of the hole if the latter is more or less vertical downward, and to the exterior of the hole if the latter is horizontal or otherwise.

At least some of the steps of the method may be carried out simultaneously or sequentially. Steps may be carried out simultaneously with an electric tool, for example using electronic circuits for controlling two or more simultaneous actions. In the case of a pneumatic tool, it may be simpler (simpler design tool) to carry out the steps sequentially.

The method may comprise the steps consisting in:
controlling the progressive introduction of the nozzle into the hole and/or the progressive withdrawal of the nozzle from the hole, through collaboration between bearing mechanisms of the tool and said wall.

The method may comprise the steps involving:
rotating the nozzle, the nozzle being kept in rotation throughout all the subsequent steps of the method,
beginning to insert the nozzle into the hole with a view to brushing same,
injecting air into the hole using the nozzle,
continuing to insert the nozzle into the hole while continuing to inject air into the hole,
possibly, halting the injection of air into the hole,
injecting resin into the hole,
beginning to withdraw the nozzle from the hole while continuing to inject resin into the hole,
continuing to withdraw the nozzle until it exits the hole, injection of resin preferably being halted before the nozzle exits the hole.

The method may comprise a preliminary step consisting in measuring the depth of said hole and comprising the substeps of:
inserting the nozzle into the hole until the nozzle bears against the bottom of the hole,
detecting the position of the bearing mechanisms of the tool on said wall, and
calculating the depth of the hole on the basis of the detected position.

The method may comprise an additional preliminary step consisting in determining a quantity of resin to be injected on the basis of the calculated depth of the hole, the tool parameters being set to inject this quantity of resin during the injection step.

According to a second aspect, the present disclosure proposes a portable tool for performing tasks in or on a wall, comprising a principal gripping grip of the tool, a trigger for actuating at least one function of the tool, and a member of elongate shape designed to form a hole in the wall or to be inserted into a hole in the wall, said tool being equipped with a depth stop designed to bear against the wall, wherein said depth stop is located at a free longitudinal end of a piston rod of a linear actuator of the tool, and wherein the tool further comprises mechanisms for controlling the actuator that are configured in order to vary the exit length of said piston rod during operation of the tool.

The actuator makes it possible to assist the tool user by imposing on him a preset distance between the tool and the wall, which results in a given depth of drilling of a hole or of insertion of the member in the hole. Within the context of the present disclosure, this distance can be varied and is modified during a phase of use of the tool, in order to control the speed of introduction of the tool relative to the wall and/or the speed of withdrawal of the tool relative to the wall. In the case of a drill, for example, control by the tool of the speed of introduction of the tool (which corresponds to the speed of withdrawal of the piston rod of the actuator) allows a preset speed of drilling the wall to be imposed on the user. In the case of a resin injection tool, for example, control by the tool of the speed of introduction of the tool (which corresponds to the speed of withdrawal of the piston rod of the actuator) may make it possible for a preset speed of cleaning the hole to be imposed on the user, and control by the tool of the speed of withdrawal of the tool (which corresponds to the speed of deployment of the piston rod of the actuator) makes it possible to impose a preset speed of injection of resin into the hole on the user. The tool thus makes it possible to inject resin at an optimum speed and to guarantee the injection of an optimum amount of resin.

The tool according to the present disclosure may comprise one or more of the following features, taken in isolation or in combination with one another:
the tool is a drill for forming said hole;
the tool is a tool for injecting chemical anchor resin into said hole;
the tool carries a nozzle of elongate shape designed to be inserted into said hole and configured to inject resin and/or air into said hole and even to brush at least one internal surface of said hole;
said control mechanisms are configured to reduce the exit length of the piston rod in accordance with a first speed during a first phase of operation of the tool and to increase the exit length of the piston rod in accordance with a second speed during a second phase of operation of the tool;
said first phase of operation is a phase of cleaning by injection of air into the hole and/or brushing of at least one wall of the hole, and the second phase of operation is a phase of injecting resin into the hole;
said actuator extends substantially parallel to said member;
the tool comprises at least one device for sensing the position of said piston rod and/or at least one contact sensor associated with said depth stop;
the tool comprises a first motor or geared motor unit for driving said member in rotation, a second motor or geared motor unit for actuating a compressor for generating compressed air, a third motor or geared motor unit for actuating mechanisms for preparation and injection of the resin, and a fourth motor or geared motor unit for actuating the actuator;
said actuator is located on a lateral or lower side of the tool;
said member and said actuator extend in one and the same substantially vertical or horizontal plane, in the conventional mode of use of the tool;
said actuator comprises a substantially cylindrical part for fitting a removable secondary grip; and
the tool comprises electric or pneumatic supply mechanisms or is configured to be connected to electric or pneumatic supply mechanisms.

The present disclosure also relates to a method for injecting chemical anchor resin into a hole in a wall using a single tool as described above, which comprises the steps:
the piston rod of the actuator being in an exit position, placing said depth stop so as to bear against said wall and inserting said longitudinal member into said hole or presenting same at the entry of the hole;
progressively reducing the exit length of the piston rod in accordance with a first speed, such that said member progressively penetrates said hole;
halting the progression of said member in the hole by the maintenance of the piston rod in a given withdrawal position;
progressively increasing the exit length of the piston rod in accordance with a second speed and injecting resin into the hole using said member, such that said member progressively exits from said hole while injecting resin; and
halting the injection of resin and waiting for the piston rod to be in an exit position before moving the depth stop away from the wall.

The method may comprise at least one of the following supplementary steps:
rotating the member;
injecting air into the hole using said member; and
brushing at least one internal surface of the hole using said member.

At least some of the steps of the method may be carried out simultaneously or sequentially.

The method may comprise a preliminary step consisting in measuring the depth of said hole and comprising the substeps of:
inserting the nozzle into the hole until the nozzle bears against the bottom of the hole,
detecting the position of the bearing mechanisms of the tool on said wall, and
calculating the depth of the hole on the basis of the detected position.

The method may comprise an additional preliminary step of determining a quantity of resin to be injected on the basis of the depth of the hole, the tool parameters being set to inject this quantity of resin during the injection step.

According to a third aspect, the present disclosure proposes a removable grip for a portable tool for performing tasks in or on a wall, comprising a first grip part that has an elongate shape and is configured to be gripped in a user's hand, and a second part for fitting on said tool, which has a slotted annular shape and comprises a slot configured to allow the fitting/removal of the grip by way of the passage of an element of the tool through said slot, wherein said slot is located at the level of said first part and extends substantially over the entire longitudinal dimension of said first part in order to define two longitudinal grip portions, and wherein the grip is configured such that a separation of said longitudinal portions gives rise to an enlargement of the slot and such that bringing said longitudinal portions together gives rise to a narrowing of the slot.

The grip is designed to be held on the element of the tool by tightening of the second fitting part on the element and more particularly by reduction of the internal diameter of this second part such that it adopts the external diameter of the element. According to the present disclosure, this reduction in diameter, which results from a narrowing of the slot, is generated simply by bringing the grip portions together. It thus suffices for a user to grip the first part of the grip with one hand and with this hand to bring the grip portions together, by clenching the fist, in order to immobilize the grip on the element of the tool. Advantageously, the grip according to the present disclosure has no screw or similar component for securing it.

In a particular exemplary embodiment of the present disclosure, the grip has 30% less weight than an equivalent prior art grip and a cost price that is one third of that of this prior art grip.

The grip according to the present disclosure may comprise one or more of the following features, taken in isolation or in combination with one another:
said second fitting part defines a fitting orifice of said element, which has a generally circular shape with an axis of revolution B;
said second part comprises, at its internal periphery, at least one rotation-preventing projecting element configured in order to interact with a complementary mechanism of said element;
said slot has a substantially radial orientation relative to said axis;
the grip has a first longitudinal plane of symmetry passing substantially through said axis B;
the grip has a second longitudinal plane of symmetry that is substantially perpendicular to said axis B;
in the free state, without constraint of the grip, said slot extends angularly about said axis B by between 5° and 20°;
said longitudinal grip portions are substantially identical;
each of said longitudinal grip portions comprises a lateral positioning stop at each of the longitudinal ends thereof, configured in order to interact with the user's hand;
the grip is formed as a single component; and
the grip is produced from an elastically deformable material, such as an elastomer.

The present disclosure further relates to a portable tool for performing tasks in or on a wall, comprising a principal gripping grip of the tool, a trigger actuating at least one function of the tool, and a member of elongate shape designed to form a hole in the wall or to be inserted into a hole in the wall, wherein the tool is furthermore equipped with a grip as described above.

The tool according to the present disclosure may comprise one or more of the following features, taken in isolation or in combination with one another:
the tool is a drill for forming said hole;
the tool is a tool for injecting chemical anchor resin into said hole; and
the second part of the grip is mounted on a ring of the tool, which comprises at least one recess for receiving said projecting element of the second part.

### BRIEF DESCRIPTION OF THE FIGURES

The present disclosure will be better understood and further details, features and advantages of the present disclosure will become more clearly apparent upon reading the following description given by way of non-limiting example and with reference to the appended drawings, in which:

FIG. 1 is a highly schematic view representing successive steps in an operation for injecting chemical anchor resin into a hole in a wall, according to the art prior to the present disclosure;

FIG. 2 is a schematic perspective view of a tool for injecting chemical anchor resin according to a first example embodiment of the present disclosure, seen from the side;

FIG. 3 is a schematic view in perspective of the tool of FIG. 2, seen from above;

FIG. 4 is a schematic view in perspective of the tool of FIG. 2, without part of its casing;

FIG. 5 is a schematic view in perspective of an element of the casing of the tool of FIG. 2;

FIG. 6 is a schematic view in perspective of the tool of FIG. 2, without its casing;

FIG. 7 is a schematic view in perspective of the tool of FIG. 2, seen from the front;

FIG. 8 is a view similar to that of FIG. 7, without certain components, in order to visualize the dynamic mixer;

FIG. 9 is a schematic view in perspective, and on a larger scale, of the dynamic mixer of the tool of FIG. 2;

FIG. 10 is a schematic view in perspective of the nozzle and of the dynamic mixer of the tool of FIG. 2, both seen from the rear;

FIG. 11 is a schematic view in perspective of the nozzle of the tool of FIG. 2, seen from the rear;

FIG. 12 is a schematic view in perspective of the nozzle of the tool of FIG. 2, seen from the front, and shows its end fitting;

FIG. 13 is a further schematic view in perspective of the nozzle of the tool of FIG. 2, seen from the front, without its end fitting;

FIG. 14 is a schematic view in perspective of the tool of FIG. 2, without its nozzle, seen from the front;

FIG. 15 is a schematic view in longitudinal section of the tool of FIG. 2;

FIG. 16 is a partial schematic view in perspective of the tool of FIG. 2, without certain components;

FIG. 17 is a partial schematic view in perspective of mechanisms for preparing and injecting resin of the tool of FIG. 2;

FIG. 18 is a schematic view in perspective of a member for driving and supplying air to the dynamic mixer of the tool of FIG. 2;

FIGS. 19a and 19b are schematic views in perspective of an actuator of the tool of FIG. 2 and represent two positions of its piston rod, respectively;

FIGS. 20a and 20f are schematic views in perspective of the tool of FIG. 2 and represent steps in a method for injecting resin into a hole in a wall;

FIG. 21 is a schematic view in perspective of a tool for injecting chemical anchor resin according to a variant example embodiment of the present disclosure, seen from the side;

FIG. 22 is a schematic view in perspective of the tool of FIG. 21 equipped with a removable secondary grip according to one aspect of the present disclosure;

FIG. 23 is a schematic view in perspective and on a larger scale of the grip of FIG. 22;

FIG. 24 is a schematic view in perspective of a ring of a tool; and

FIG. 25 is a very schematic view of mechanisms for actuating resin injection and the withdrawal of a tool with a pneumatic logic component.

### DETAILED DESCRIPTION

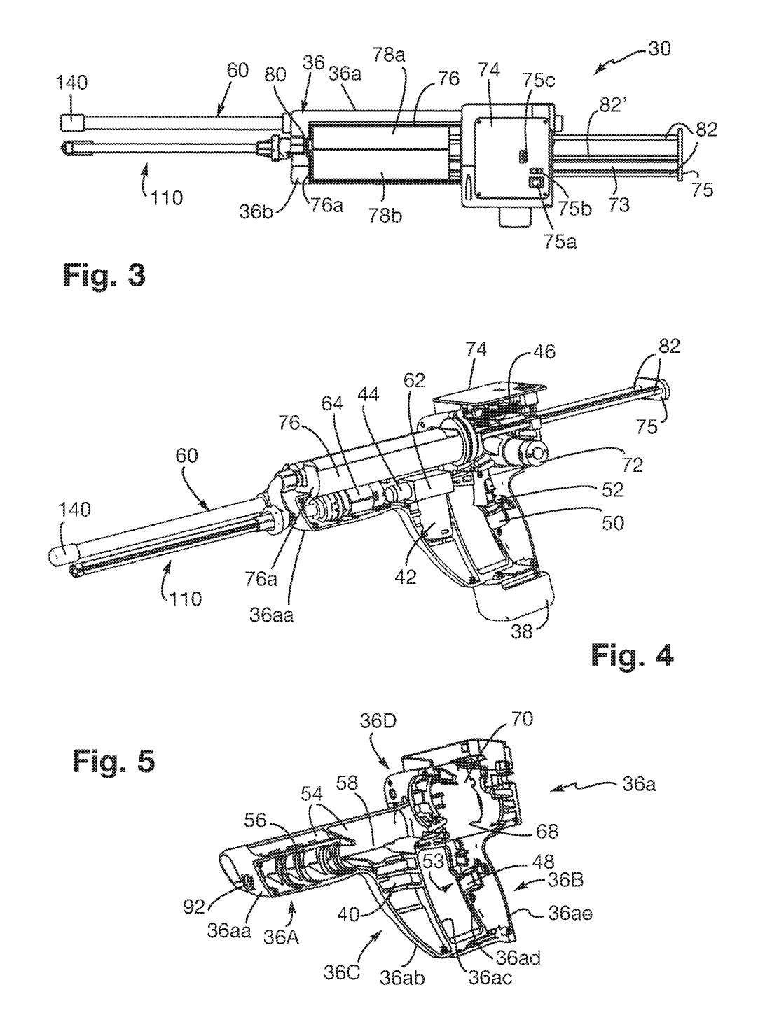

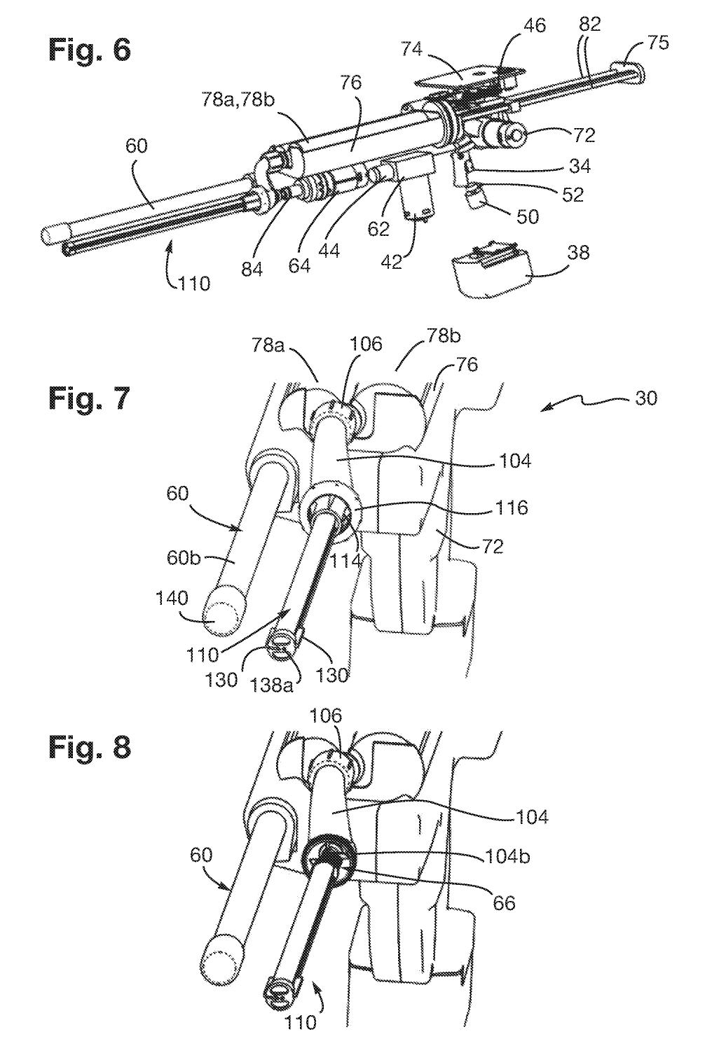

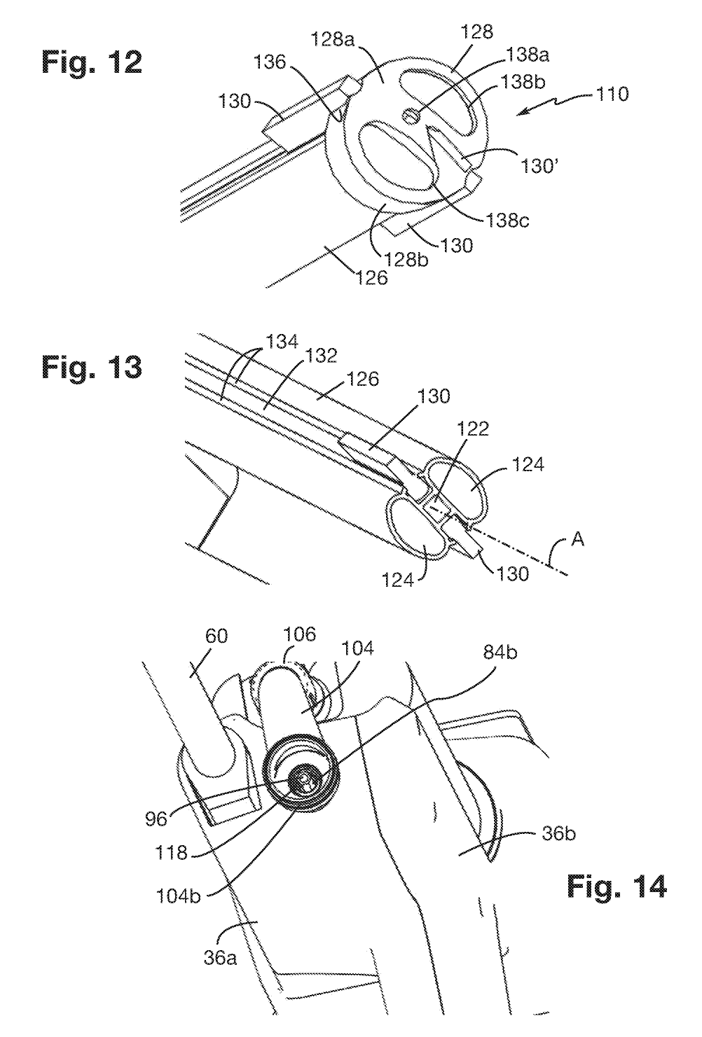

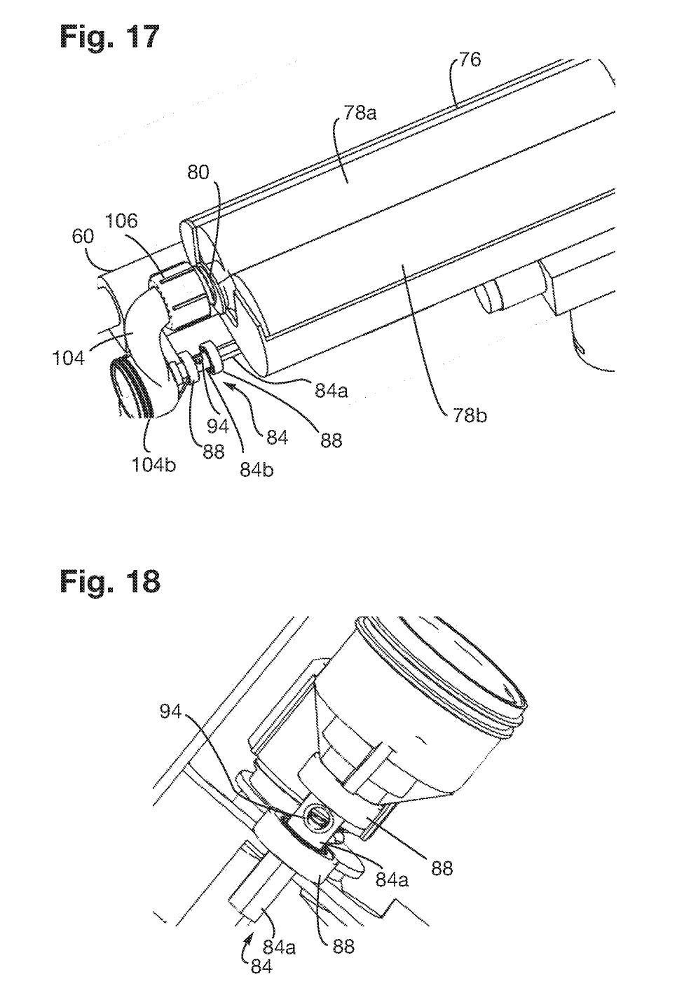

FIGS. 2 to 20f represent a first embodiment of a tool 30, according to the present disclosure, for injecting chemical anchor resin into a hole in a wall.

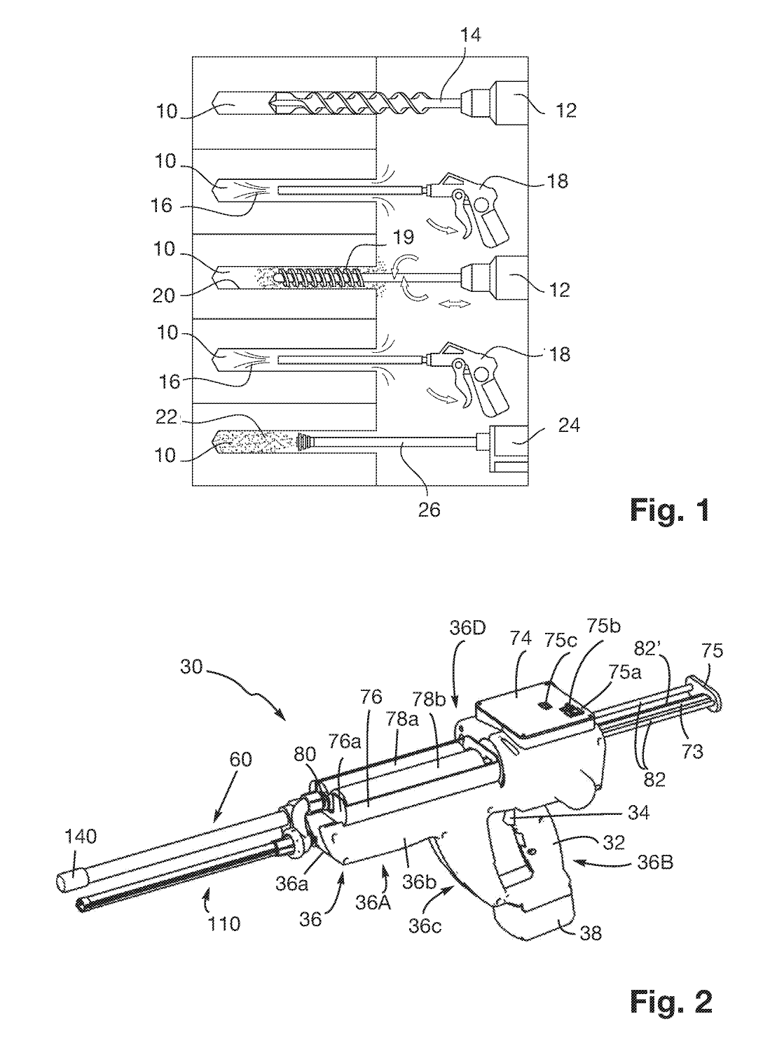

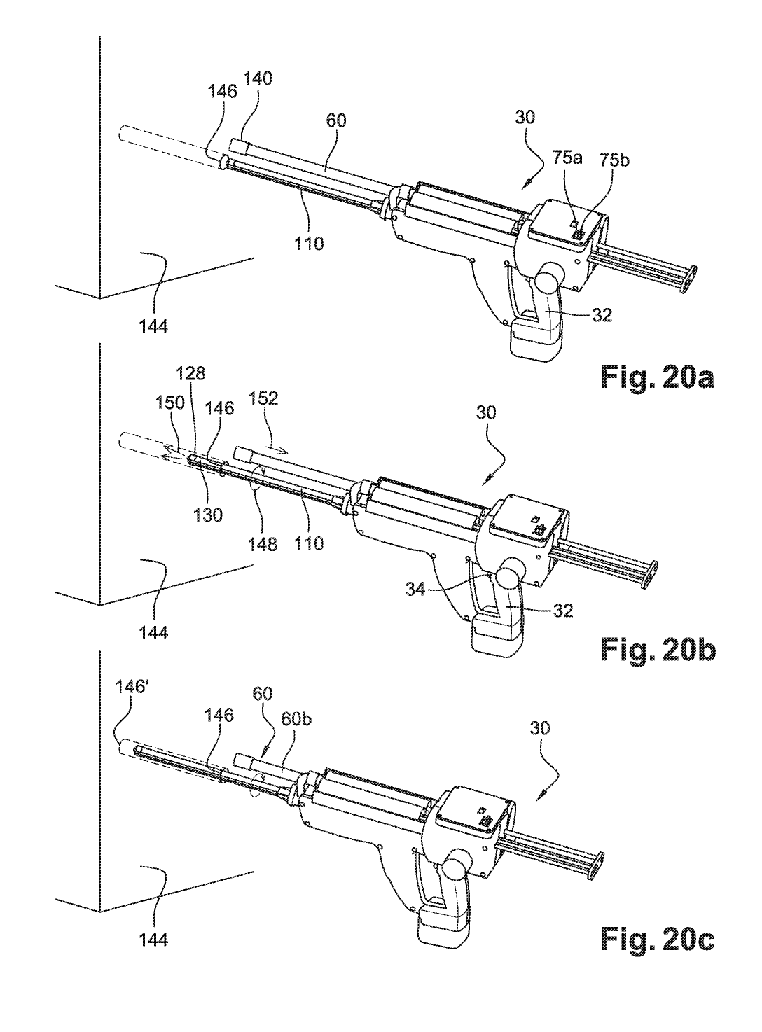

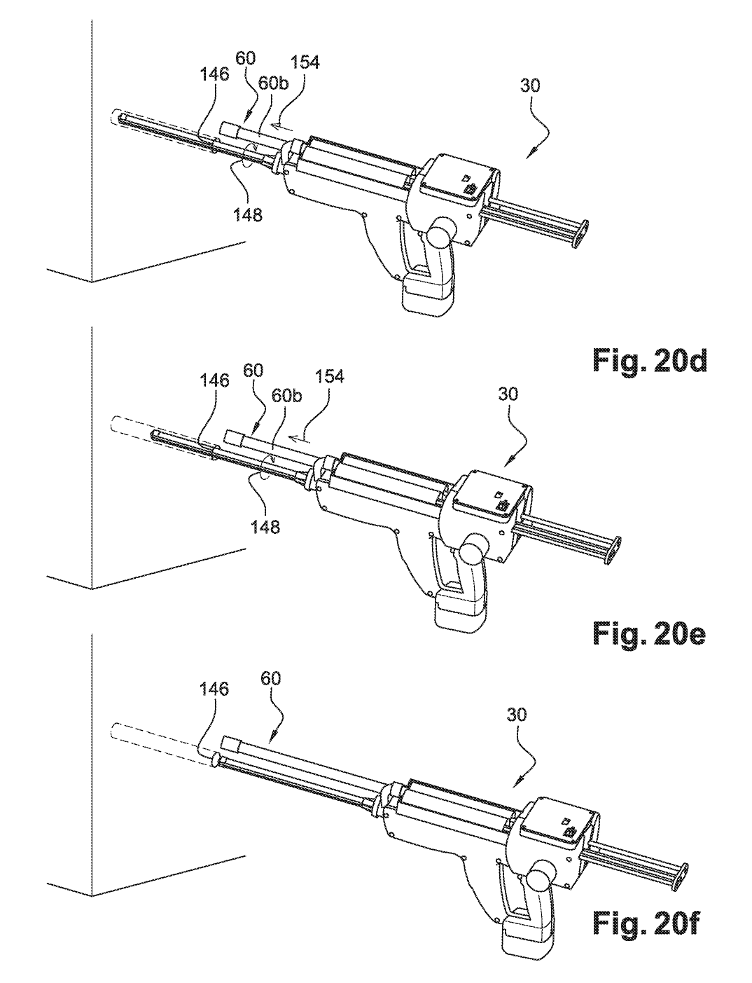

FIGS. 1 to 19b will be used below to illustrate the various components of the tool 30, and FIGS. 20a to 20f will be used to illustrate a method of use of the tool, i.e. a method for injection of resin into a hole in a wall.

The tool 30 is portable and has a general gun shape. It comprises a main grip 32 equipped with a trigger 34 for actuating at least one function of the tool.

The tool 30 comprises a casing 36 having a general L shape and comprising, in use mode, i.e., when an operator or user is holding the tool by its grip 32 and injects resin into a hole extending substantially horizontally, a first, horizontal longitudinal part 36A and a second, vertical longitudinal part 36B and defining said grip 32. The casing 36 further comprises, in front of the grip 32, a third, longitudinal part 36C substantially parallel to the second part 36B. The second and third parts 36B and 36C extend downward from the first part. Lastly, the casing 36 comprises, at the junction between the first and second parts 36A and 36B a fourth part 36D that is slightly oversized, in particular in terms of width, relative to the other parts. The various parts 36A to 36D of the casing 36 extend substantially in one and the same vertical plane.

The casing 36 comprises, here, two elements or components: a principal body 36a represented on its own in FIG. 5 and a cover 36b attached and secured to the body 36a, for example by way of a screw. The cover 36b defines all or practically all of an external lateral wall (here, the left-hand wall) of the tool. This cover 36b defines external lateral walls of the first, second, third, and fourth longitudinal parts 36A to 36D of the casing set forth above.

The body 36a defines the other external surfaces of the tool and, in particular, all or practically all of the other external lateral wall (here, the right-hand wall) of the tool, and also a front wall 36ac of the tool and, in particular, of the first longitudinal part 36A of its casing 36, front 36ab and rear 36ac walls of the third part 36C of the casing, and front 36ad and rear 36ae walls of the second part 36B or grip 32 of the casing.

The lower ends of the second and third parts 36B and 36C of the casing are connected together and comprise mechanisms for securing a removable battery 38 for electrically powering the tool 30. As an alternative, the tool might be powered pneumatically.

As can be seen in FIG. 5, the body 36a of the casing 36 defines housings for receiving a plurality of elements of the tool. The third part 36C of the casing here defines a housing 40 for receiving a motor or geared motor unit 42 for driving a compressor 44 for generating compressed air. The geared motor unit 42 extends between the aforesaid front 36ab and rear 36ac walls. It is connected electrically to at least one electronic control board 46, which is itself connected electrically to the battery 38.

The second part 36B of the casing defines, here, a housing for receiving a part of the trigger 34 and also a housing 48 for receiving a potentiometer 50 carrying a thumb wheel 52 accessible to the user via a window 53 in the handle 32. The potentiometer 52 is connected to the electronic board 46 and makes it possible to vary the speed of injection of resin by default—during an initialization operation, which will be described in detail below.

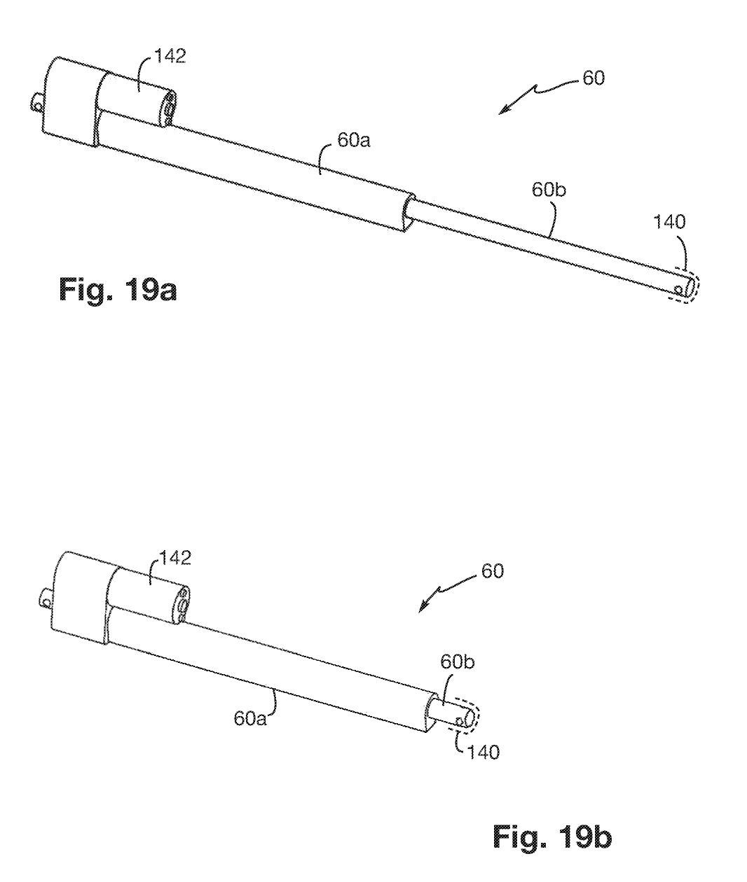

The first part 36A of the casing defines, here, a plurality of housings 54, 56, and 58. The housing 54 is located on a side (here, the right-hand side) of the casing 36 and extends over substantially all the longitudinal dimension of the first part 36A and of the fourth part 36D of the casing. This housing 54 receives an electric linear actuator 60, visible in FIGS. 19a and 19b.

The housings 56 and 58 are located on the other side (here, the left-hand side) of the casing 36, and are located longitudinally one 58 behind the other 56. The rear housing 58 is located substantially above the housing 40 and receives the compressor 44, or even a gearbox or reducing gearbox 62 mechanically connecting the output shaft of the geared motor unit 42 to the rotor of the compressor 44.

The front housing 56 receives a motor or geared motor unit 64 for driving a dynamic mixer 66, visible in FIGS. 8 to 10, in rotation. The geared motor unit 64 extends rearward from the aforesaid front wall 36aa and is electrically connected to the electronic board 46.

The fourth part 36D of the casing defines, in addition to the aforesaid housing for receiving a part of the actuator 60, respective lower and upper housings 68 and 70. The lower housing 68 receives a motor or geared motor unit 72 used for the preparation and injection of the resin. It is electrically connected to the electronic board 46. The upper housing 70 receives the electronic control board or boards 46, which are accessible by removal of an upper cowling 74 of the casing 36.

In the example represented, the cowling 74 is flat and has a substantially rectangular shape. It carries a switch 75a for switching on the tool, a switch 75b for selecting between two operating modes of the tool, namely an “initiation” mode and an “injection” mode, and, optionally, a control screen 75c.

The first part 36A of the casing 36 is open at its upper end and receives a member 76 for receiving at least one cartridge for the preparation of the resin and, in this case, two cartridges 78a and 78b. The cartridges extend parallel to one another and extend in one and the same substantially horizontal plane, in the conventional use mode. The cartridge 78a comprises a polymerizable resin based on at least one monomer and the cartridge 78b comprises a hardening agent or crosslinking agent (or vice-versa), the mixing of these two components giving rise to the polymerization of the resin and its hardening.

The cartridges 78a and 78b are consumables, and the member 76 is open on the top to facilitate the fitting/removal of the cartridges. Each cartridge 78a and 78b comprises a cylindrical body, one end of which (here, the front end) is closed and the opposite end (the rear end) of which comprises a base slidably mounted inside the cylindrical body. The front ends of the cartridges bear on a front wall 76a of the member and comprise a common component outlet fitting 80. The rear ends of the cartridges are located in front of the fourth part 36D of the casing 36 and receive circular heads of pistons, the rods 82 of which traverse the fourth part 36D of the casing, passing between the housings 68 and 70 and extending toward the rear of the tool, in particular when the pistons are in the completely exited position, as shown in FIGS. 2 to 4. The pistons are electrically actuated by way of the geared motor unit 72. The output shaft of the geared motor unit 72 carries a pinion that is meshed with a rack 73, the rear end of which is connected to a plate 75 secured to the two rods 82. A third rod 82′, parallel to the rods 82 and secured to the plate 75, is visible in the drawings. It serves as guide at the time of the translational movement of the assembly formed by the rods 82, the rack 73 and the plate 75.

The tool 30 thus comprises three distinct motors or geared motor units 42, 64, and 72, one for actuating the compressor 44, one for actuating the dynamic mixer 66, and the last for actuating pistons for preparation and injection of resin. It will be seen below that the tool comprises a further motor or geared motor unit.

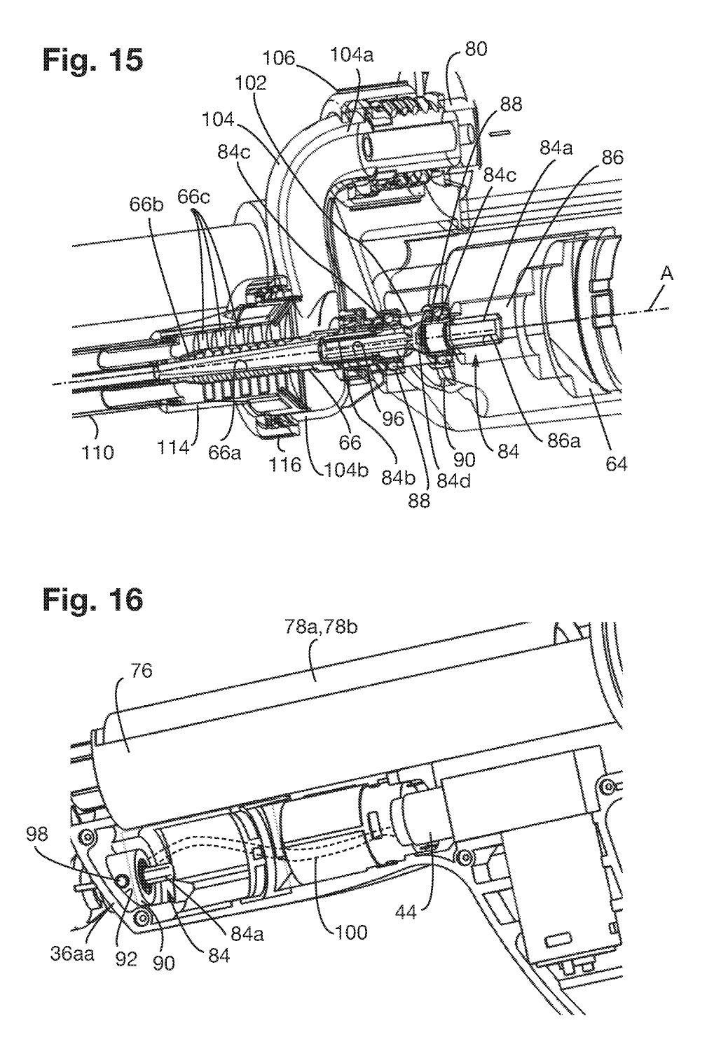

As may be seen in FIGS. 15 to 18, the geared motor unit 64 drives the dynamic mixer 66 by way of a drive or linking member 84. The linking member 84 has an elongate shape and extends along the axis A of rotation of the output shaft 86 of the geared motor unit. The linking member 84 comprises a rear longitudinal end 84a configured in order to be connected to the output shaft 86, rotating as one with this shaft 86. This end 84a has, here, in cross section, a hexagonal shape and is engaged in a bore 86a of a shape complementing the output shaft 86.

The linking member 84 comprises a front longitudinal end 84b configured in order to be connected to the dynamic mixer 66, rotating as one therewith. This end 84b likewise has a hexagonal shape in cross section and is engaged in a rear end portion of a shape that complements a bore 66a of the mixer 66.

The linking member 84 comprises, between its ends 84a and 84b, two cylindrical portions 84c surrounded by rolling bearings 88, in this case ball bearings, which make it possible to center and to guide the member in rotation about the axis A. The bearings 88 are carried by a stator bushing 90 mounted securely in the casing 36. This bushing 90 is inserted into a through-orifice 92 of the aforesaid front wall 36aa of the casing, which is visible in FIG. 5.

The linking member 84 comprises, between its cylindrical portions 84c, an intermediate cylindrical portion 84d comprising an orifice 94 extending substantially perpendicularly to the axis A. This orifice 94 is a through-orifice and thus opens out on two diametrically opposed sides of the intermediate portion 84d.

The linking member 84 further comprises an internal bore 96 that extends along the axis A from the front free end thereof up to in line with the orifice 94. The bore 96 and the orifice 94 are thus in fluidic communication.

As may be seen in FIG. 16, the bushing 90 comprises a connection port 98 at one end of a flexible air circulation hose 100, the opposite end of which is connected to the air outlet of the compressor 44. This hose 100 is, here, represented in broken lines. The bushing 90 extends around the intermediate portion 84d of the member 84 and defines therewith an annular cavity 102 delimited axially by the bearings 88. The port 92 opens out into this cavity 102, which is thus supplied with air by the compressor 44.

The components of the cartridges 78a and 78b are brought as far as the dynamic mixer 66 by way of an elbowed duct 104, which is substantially in the shape of an S. This duct 104 comprises an end, in this case an upper end 104a, for connection to the fitting 80 of the cartridges. A nut 106 is mounted permanently on the end 104a of the duct 104, which opens rearward, and is screwed onto an external screw thread of the fitting 80 with a view to the tightening of the end 104a on the fitting 80 and the establishment of a leaktight connection between these elements.

The duct 104 comprises a lower end 104b for connection to a nozzle 110 of the tool 30, for injection of resin. This end 104b comprises an external screw thread and opens forward. This end is centered on the axis A and receives the dynamic mixer 66.

The mixer 66 comprises a longitudinal body 66b of axis A that carries, at its periphery, a multitude of fins 66c for mixing the components of the resin. The body 66b is tubular and thus comprises an internal bore 112 extending over the entire length of the body and defining, at its downstream end, the aforesaid portion of hexagonal cross section for receiving the front end of the member 84. As can be seen in FIG. 14, in particular, the front end of the member 84 passes through an orifice in a base wall of the duct 104.

The mixer 66 is housed partly in the lower end 104b of the duct 104 and partly inside a substantially cylindrical or frustoconical ring 114 attached to the end 104b of the duct. A nut 116 is mounted on the ring 114 and is screwed onto the screw thread of the end 104b with a view to the tightening of the ring on the end 104b and the establishment of a leaktight connection between these elements. The ring 114 comprises, at its front end, an orifice 118 traversed by the front part of the mixer 66.

The duct 104 may be equipped with at least one seal at each of its ends 104a and 104b, such as, for example, O-rings.

As can be seen in FIG. 15, the body 66b of the mixer 66 defines, with the ring 114, an annular flow channel for the resin during mixing. The mixer 66 comprises, at its front end, two tubular elements 120 for connection to the nozzle 110 and for supplying resin to this nozzle. The elements 120 are substantially identical and diametrically opposed relative to the axis A and receive the resin originating from the channel, which is thus separated into two material streams. The internal bore of the body 66b of the mixer 66 defines an axial passage for circulation of air originating from the compressor 44 and designed to supply the nozzle 110. The mixer 66 is, here, formed as a single component.

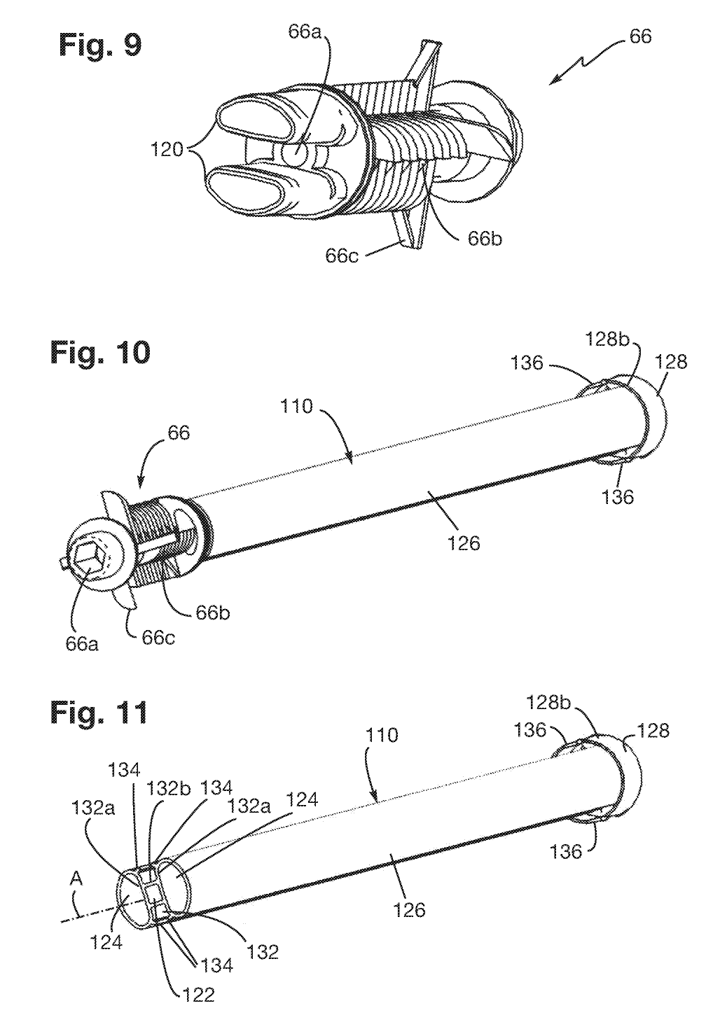

As can be seen in FIG. 9, the front air outlet end of the bore 66a of the mixer 66 has, in cross section, a substantially circular shape. This end is designed to be aligned with a canal 122 of similar or dissimilar shape to the nozzle 110. The tubular elements 120 have two planes of symmetry passing via the axis A and respectively horizontal and vertical. This tubular element 120 has, in cross section, a substantially half-circular or half-disk shape and is formed in order to be engaged forcibly in a duct 124 of complementary shape to the nozzle 110. In the assembled position, the nozzle 110 is designed to bear axially on the front end of the body 66b of the mixer.

The nozzle 110 of the tool is more visible in FIGS. 10 to 13. As is the case for the cartridges 78a and 78b, the nozzle 110 represents a consumable that has to be replaced after one or more successive resin injection operations owing to the clogging of the nozzle by resin that has hardened after polymerization.

In the example shown, the nozzle 110 comprises three elements overall: a body 126 of elongate rectilinear shape, an end fitting 128 and brushing mechanism 130.

The body 126 is formed as a single component from plastics, for example transparent plastics. It may be formed by extrusion or injection-molding. It comprises, here, two internal longitudinal ducts 124 for the passage of resin and an internal longitudinal canal 122 for the passage of air. The ducts 124 and the canal 122 extend over substantially the entire longitudinal dimension of the body and open out at each of the longitudinal ends thereof.

The canal 122 extends to the center of the body and is traversed by the longitudinal axis of the body, which merges with the aforesaid axis A when the nozzle 110 is mounted on the tool and, in particular, on the elements 120 of the mixer 66. This canal 122 has, here, in cross section, a substantially parallelepipedal shape—in this case, a square shape.

The ducts 124 extend on either side of the canal 124 and are diametrically opposed relative to the axis A. As indicated above, they have, in cross section, a shape similar to that of the fittings 120 so that it is possible to sleeve the nozzle 110 over these fittings. Each duct has, in cross section, substantially the shape of a half-circle or half-disk.

As can be seen in the drawings, the ducts 124 are separated from one another by a longitudinal space in the middle part of which the canal 122 extends. The lateral parts of this space are open to the exterior and define lateral longitudinal grooves 132. These grooves 132 extend over the entire longitudinal dimension of the body 126. In cross section they each have a parallelepipedal shape—in this case, a square shape—and are delimited by two substantially parallel lateral walls 132a common to the ducts 124, and a base wall 132b common to the canal 122. The longitudinal edges of the lateral walls 132a of each groove 132, opposite the base wall 132b of this groove, are connected to two longitudinal lips 134 that converge toward one another toward the exterior of the nozzle 110.

As can be seen in FIG. 13, these grooves 132 are designed to receive the aforesaid brushing mechanism, and in particular brushes 130. In the example shown, the nozzle 110 carries two brushes 130 mounted respectively in the grooves 132 of the body of the nozzle. Each brush 130 has a general planar and parallelepipedal shape and is located at the front end of the nozzle 110. The brushes 130 are diametrically opposed and coplanar. They each comprise a part that is radially internal relative to the axis A, inserted forcibly or engaged by sliding in the grooves 132 and held radially therein by the lips 134, by abutment and/or pinching.

Each brush 130 may be formed by a pad or block of flexible material. In this case, the lips 134 are able to interact with longitudinal ribs provided on the brushes in order to guarantee they are retained in the grooves 132. In a variant, each brush 130 comprises a plurality of bristles that can be secured to one another by way of a common support designed to pinch the ends of the bristles. In a variant, the support may be overmolded on the bristles or glued thereto. The bristles may be made from plastics, such as polyamide, or from a metal material, such as steel. In this case, it is the support itself that is inserted slidably or forcibly into the grooves and can interact with the lips 134 in order to guarantee retention of the brushes 130 in the grooves 132.

Rotation of the nozzle 110 enables the brushes 130 to sweep the internal cylindrical surface of the hole in the wall in which the nozzle is engaged.

The end fitting 128 is attached and secured on the front end of the body 126, for example by simple nesting and interaction of shapes. It comprises a front wall 128a in the form of a disk connected at its external periphery to a rear cylindrical lip 128b. The lip 128b is designed to extend around the front end of the body 126 and can be forcibly mounted on this end. The lip 128b comprises a slot 136 at the location of each groove 132 of the body, so as to receive a part of the corresponding brush 130.

The front wall 128a of the fitting 128 comprises three openings 138a, 138b and 138c, which are through-openings in the longitudinal direction. A first opening 128a is located substantially at the center of the wall 128a and aligned on the axis A, or close to this axis, in such a manner as to be in fluidic communication with the canal 122 of the body 126 of the nozzle 110. The opening 128a is substantially circular.

The other openings 128b and 128c are located on either side of the opening 128a and are diametrically opposed relative to the axis A. They have the shape of a half-circle or half-disk, similar to the cross-sectional shape of the ducts 124, and are positioned around the axis A so as to be in fluidic communication with the ducts 124, respectively.

The front wall 128a further comprises a rib 130′ projecting toward the front. The rib 130′ has a substantially radial orientation relative to the axis A. It has a length or radial dimension corresponding substantially to the radius of the nozzle 110, its radially internal end being on the axis A. Rotation of the nozzle 110 gives rise to a helical movement of the air inside the hole, which tends to be expelled toward the exit of the hole, taking with it the dust initially present in the hole. This rotation of the air is, in particular, caused by the scoop effect generated by the rotation of the rib 130′ and of the brushes 130.

Reference is now made to FIGS. 19a and 19b, which show the actuator 60 detached from the rest of the tool 30.

The actuator 60 comprises a cylinder 60a inside which a piston rod 60b is slidably mounted, the free end of which, opposite the cylinder 60a, bears a depth stop 140 designed to bear on the wall that has the hole. The depth stop 140 is represented in broken lines in FIGS. 19a and 19b and can be seen in FIGS. 2 to 4, in particular. The depth stop 140 may be made from a flexible or resilient material, such as an elastomer, to facilitate the positioning and maintenance in position of the tool on the wall and to absorb possible shocks.

Preferably, the depth stop 140 is associated with a contact sensor connected to the electronic board 46. In the course of an injection operation, the depth stop 140 has to be in permanent contact with the wall. If the electronic board 46 receives information from the sensor that the depth stop is not bearing on the wall, it may decide to continue the steps of injecting air and/or injecting resin, or preferably may place them on standby, these steps being resumed only when the depth stop is again placed against the wall.

The actuator 60 is linear, that is to say the piston rod 60b has a rectilinear deployment course and can move between a first, exit position, shown in FIG. 19a, and a second, withdrawn position, represented in FIG. 19b.

The actuator 60 is, moreover, electric, because it is powered electrically by a motor or geared motor unit 142, independent of the other three geared motor units mentioned above. This geared motor unit 142 is electrically connected to the electronic board 46 of the tool.

The electronic board 46 comprises all the elements necessary for controlling the electrical equipment of the tool 30 and, in particular, motors or geared motor units. It comprises at least one microprocessor configured to control the actuator 60 and, in particular, the electrical powering of its geared motor unit 142, in such a manner as to define a speed V1 of withdrawal of the piston rod (passage from the position in FIG. 19a to the position in FIG. 19b), which may be different from the speed V2 of exit or deployment of the piston rod 60b (passage from the position in FIG. 19b to the position in FIG. 19a).

As will be described in more detail below, the speed V1 is determined to optimize brushing in the hole and the speed V2 is determined to optimize injection of resin into the hole.

The microprocessor of the electronic board 46 is preferably configured to control the pistons of the mechanisms for preparing and injecting resin such that the rods 82 of the pistons have a predetermined displacement speed V3.

Advantageously, the speed of injection of the resin, which is a function of the speed V3 of displacement of the rods 82, is slaved to the speed V2 of deployment of the piston rod 60b.

Preferably, the electronic board 46 is connected to an ambient temperature sensor. The board 46 thus receives information relating to the exterior temperature and can adapt the speed V3 as a function of this temperature in order to take account of the influence of this temperature on the viscosity of the resin.

The actuator 60 preferably comprises a device for sensing the position of its piston rod 60b (such as a contactor) such that the electronic board 46 is able to deduce the depth of the hole on the basis thereof and to take account of this latter parameter to determine the optimum quantity of resin to be injected and as a result to control the geared motor unit 72.

Reference is now made to FIGS. 20a to 20f, which represent steps in a method for injecting resin using the tool 30.

Prior to the steps illustrated in FIG. 20a et seq., a hole 146 should be drilled in a wall 144 using a drill, for example. The hole 146 has, for example, a diameter of the order of 20 millimeters for a length of the order of 20 centimeters.

There should also be a preliminary step of mounting consumables on the tool 30, namely the cartridges 78a and 78b, in the member 76, and the nozzle 110 on the elements 120 of the mixer 66. There then has to be an initiation phase, with the operator starting this phase by switching on the tool using the switch 75a and then placing the switch 75b in the “initiation” position. The aim of this phase is to fill the nozzle 110 with resin. Upon activation of this phase, the electronic board 46 of the tool controls the geared motor units 64 and 72 such that the components exit the cartridges 78a and 78b and are conveyed via the duct 104 to the mixer 66, which mixes them and forces them to pass into the elements 120 and then into the ducts 124 of the nozzle 110. The resin is thus mixed prior to its injection into the nozzle, which makes it possible to reduce its viscosity and to facilitate its flow in the nozzle. The initialization step is completed when the resin flows through the openings 138b and 138c in the end fitting 128 of the nozzle. The operator can then place the switch 75b in the “injection” position, which stops the actuation of the motors of the tool.

A first step of the method, illustrated in FIG. 20a, consists in positioning the tool 30 in front of the wall 144 comprising the hole 146, in placing the depth stop 140 of the actuator 60 so as to bear against the wall 144, and in aligning the axis of the nozzle 110 on the axis of the hole 146. This step, and also the following steps, are performed manually, with an operator directly manipulating the tool 30 by holding it by way of its grip 32.

A next step consists in applying pressure to the trigger 34 of the grip 32 of the tool in order to start an operation of injecting resin into the hole 146. In the course of this operation, the electronic board 46 of the tool controls:
the geared motor unit 42, with a view to the generation of compressed air (arrows 150); the compressed air exits the compressor and is conveyed by the hose 100 as far as the port 98 of the bushing 90; this air supplies the cavity 102 and penetrates the bore 96 of the linking member 84 via the orifice 94; this air then flows along the member 84 and as far as into the bore 66a of the mixer 66, in order to then be injected into the internal canal 122 of the nozzle 110; the air is expelled at the front end of the nozzle 110 via the opening 138a in the end fitting 128 of the nozzle; the volume of air expelled may be of the order of 10 L per injection operation; the ratio between the volume of air expelled and the volume of the hole 146 is preferably greater than 1000 and, for example, of the order of 1600;
the geared motor unit 142 with a view to the progressive withdrawal of the piston rod 60b of the actuator 60 (arrow 152); the operator is supposed to hold the depth stop 140 bearing against the wall 144; it will thus be understood that, as the piston rod 60b of the actuator 60 withdraws, the nozzle 110 penetrates the hole 146 to an increasing depth; the aforesaid withdrawal speed V1 of the rod 60b thus determines the speed of insertion of the nozzle 110 in the hole 146; and
the geared motor unit 64 with a view to rotating the nozzle 110 (arrow 148), for example at a speed of 450 revolutions/minute; the rotation being transmitted to the nozzle by way of the linking member 84 and the mixer 66; the brushes 130 of the nozzle 110 have their radially external ends located on a circumference centered on the axis A, which preferably has a diameter at least equal to and, if possible, slightly greater than the internal diameter of the hole 146; rotation of the nozzle 110 causes rotation of the brushes 130 and thus a brushing of the internal cylindrical surface of the hole 146.

In the step in FIG. 20b, there is thus simultaneously injection of air into the hole 146 (arrows 150) and brushing of the inside of the hole (arrow 148), which makes it possible to properly clean the inside of the hole and to remove any dust and debris therefrom. The combination of the rotation of the nozzle 110 and of the introduction of the nozzle into the hole allows sweeping of the inside of the hole by helical movements. The rib 130′ and the brushes 130 undergo these helical movements, which will generate a helical movement of the air that will facilitate its expulsion outside of the hole, entraining dust and debris therewith.

The insertion of the nozzle 110 into the hole 146 is continued until the end fitting 128 of the nozzle comes to bear on the bottom of the hole or, preferably, until the piston rod 60b of the actuator 60 is completely withdrawn (FIG. 20c). This situation enables the electronic board 46 of the tool to ascertain the (minimum) depth of the hole. Insofar as the nozzle 110 has come to bear against the bottom of the hole via its fitting 128, the information coming from the device for sensing the position of the piston rod of the actuator 60 allows determination of the depth of the hole, subtracting the remaining length of the piston rod from the length of the rod when it is completely deployed. If the piston rod of the actuator has had to be completely withdrawn, the electronic board 46 is able to deduce therefrom that the depth of the hole is at least equal to the deployment course of the piston rod of the actuator. Knowledge of the depth of the hole on the part of the electronic board 46 makes it possible, in particular, to adjust the quantity of resin to be injected in the course of the next step.

The injection of resin into the hole 146 can commence in the next step, shown in FIG. 20d. In this step, the electronic board 46 of the tool controls:
the geared motor unit 42, with a view to halting or not halting generation of compressed air;
the geared motor unit 142, with a view to the progressive deployment of the piston rod 60b of the actuator 60 (arrow 154); the operator is supposed to keep the depth stop 140 bearing against the wall 144; it is thus understood that, as the piston rod 60b of the actuator 60 is deployed, the nozzle 110 progressively exits the hole 146; the aforesaid speed V2 of deployment of the rod 60b thus determines the exit speed of the nozzle 110 from the hole 146;
the geared motor unit 64 with a view to rotating the nozzle 110 (arrow 148), for example at a speed of 450 revolutions/minute; the rotation being transmitted to the nozzle by way of the linking member 84 and the mixer 66; and
the geared motor unit 72 for actuating the rack 73 and rods 82; owing to the aforesaid initialization phase, components have already been introduced into the duct 104 and resin has already been mixed by the mixer 66 and introduced into the nozzle 110, which is thus full of resin; actuation of the geared motor unit 72 thus gives rise to a practically immediate exit of the resin from the start of withdrawal of the piston rod 60b of the actuator 60; the speed of injection of the resin into the hole (which depends on the speed V3 of displacement of the rods 82) is slaved to the speed V2 of withdrawal of the piston rod 60b such that an optimum quantity of resin is injected into the hole. An insufficient speed of injection of injected resin would lead to a deleterious presence of air bubbles trapped in the hole, whereas too high a speed could lead to soiling of the brushes 130 of the nozzle 110.

If there were to be a sudden change in flow rate or in the injection speed of the resin into the hole, the electronic board 46 is able to adjust the parameters for controlling the geared motor unit 72 with a view to maintaining correct injection. The relationship between the injected resin flow rate Q and the speeds V1 and V3 is Q=V3*S3=V2*S, with S and S3 respectively being the cross section of the hole 146 and the equivalent cross section of the cartridges 78a and 78b. Preferably, the speed V2 has to be adjusted such that V2=(V3*S3)/S.

The step of resin injection is continued at least until such time as the end fitting 128 of the nozzle 110 is located substantially mid-way into the hole 146 (FIG. 20e). That this half-depth has been reached can easily be deduced by the electronic board 46, simply by dividing the depth of the hole calculated in the preceding step by two.

The following step then consists in continuing the exit of the nozzle 110 from the hole 146 while continuing deployment of the piston rod 60b as far as its completely deployed position, in which the nozzle 110 is completely extracted from the hole 146 (FIG. 20f). In this phase of exit of the nozzle, air may be injected into the hole if necessary. The electronic board 46 then controls the stopping of the geared motor units and awaits a further order from the operator, by way of the trigger 34, to launch a new injection operation.

The tool 30 may be configured such that permanent pressure on the trigger is necessary to perform the method as a whole or, alternately, one-off pressure suffices to initiate the method, which continues for as long as there is no further pressure on the trigger, unless, of course, the end of the last step in the method arises before this further pressure on the trigger. In the aforesaid first case, the electronic board 46 is able to stop the actuation of the geared motor units, which actuation would not be resumed until after there is further pressure on the trigger.

At least some steps of the method may be carried out simultaneously. This is the case, for example, when the nozzle is withdrawn, of the resin potentially being injected simultaneously into the hole.

As an alternative, at least some, and for example all, of the steps of the method are carried out sequentially, i.e., one after another. This is the case, for example, when the nozzle is stationary and injection is commanded, then injection is stopped and the nozzle is withdrawn. The operation of the tool is thus of the discrete rather than continuous type, which is easier to implement with certain tool technologies, for example pneumatic technologies. In effect, in this case, the pneumatic tool may be simplified, in particular concerning the number of its sensors.

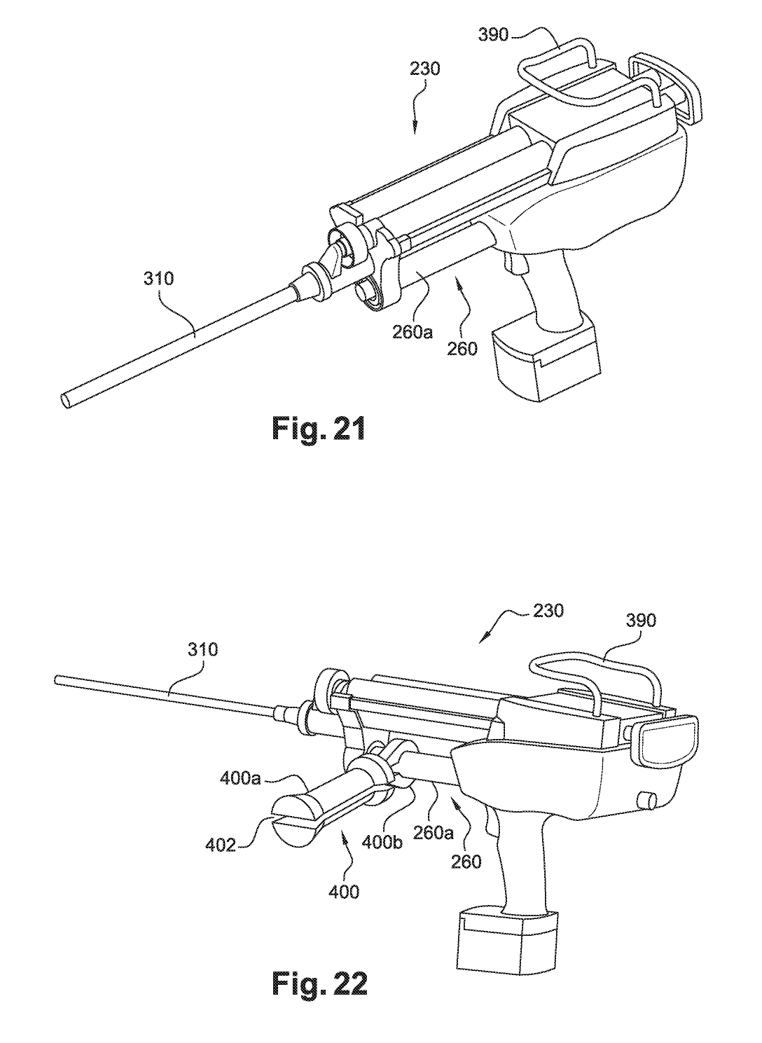

Reference is now made to FIGS. 21 to 23, which represent a variant embodiment of the tool 230 according to the present disclosure. This tool 230 globally comprises all the features of the tool 30 described above. It is distinguished therefrom only by the following points.

The tool 230 comprises, at its upper and rear end, an arched hoop 390 forming an attachment mechanism of the tool.

The electric linear actuator 260 has the same function as the aforesaid actuator 60. Instead of being placed alongside the nozzle and in one and the same substantially horizontal plane, as in the above case, the actuator 260 is, here, located under the nozzle 310 and in one and the same substantially vertical plane in the conventional use mode (horizontal nozzle 310). In FIGS. 21 to 23, the actuator 260 is represented with its piston rod not visible because the latter is completely withdrawn.

In the example shown, the body 260a of the actuator 260 comprises an external cylindrical surface on which a secondary grip 400 is removably mounted (FIG. 22).

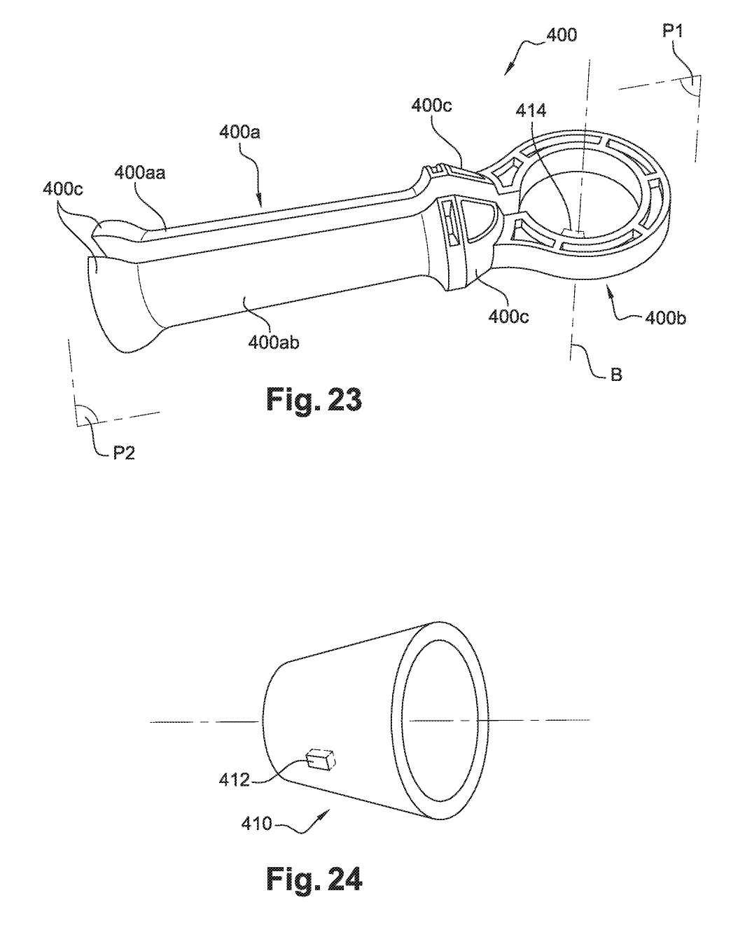

According to one aspect of the present disclosure, the grip 400 comprises a first, gripping part 400a, which has an elongate shape and is configured to be clasped in a user's hand, and a second part 400b for mounting on the tool, which has a slotted annular shape (FIG. 23).

The second part 400b comprises a slot 402 configured to allow the fitting/removal of the grip 400 on the cylinder 260a of the actuator 260 by way of the passage of this cylinder through the slot 402.

The slot 402 is located at the level of the first part 400a and extends substantially over the entire longitudinal dimension of this first part in order to define two longitudinal grip portions 400aa and 400ab, respectively lower and upper portions in the example shown.

The grip 400 is configured such that separation of the longitudinal portions 400aa and 400ab give rise to an enlargement of the slot 402 and such that a bringing-together of these longitudinal portions give rise to a narrowing of the slot.

When the grip 400 is mounted on the cylinder 260a of the actuator 260 and the second part 400b thereof surrounds the surface of the cylinder 260a, it suffices for the user to clasp the first part 400a of the grip by hand and with this hand to bring the portions 400aa and 400ab together, by clenching the fist, in order to achieve immobilization of the grip on the cylinder 260a. This immobilization is obtained by simple tightening and friction of the second part 400b on the surface of the cylinder 260a.

In the example shown, the second part 400b defines a fitting orifice of the cylinder 260b, which has a generally circular shape with an axis of revolution B. The internal diameter of this second part 400b is preferably greater than the external diameter of the cylinder 260b when the grip is in the free state, without constraint. In this free state of the grip, without constraint, the slot preferably has an angular extent about said axis B of between 5° and 20°.

The slot 402 has, here, a substantially radial orientation relative to the axis B. The grip 400 has a first longitudinal plane of symmetry P1 passing substantially through the axis B. It has a second longitudinal plane of symmetry P2 substantially perpendicular to the axis B.

The longitudinal portions 400aa, 400ab are substantially identical in the example shown. Each of these portions comprises a lateral positioning stop 400c at each of its longitudinal ends, which is configured in order to interact with the user's hand.

The grip 400 is preferably formed as a single component, for example from an elastically deformable material, such as elastomer. In this case, it is designed to deform elastically when the portions 400aa, 400ab are manually brought together.

Although the grip 400 is, here, mounted on a resin injection tool, it could be mounted on a drill, for example just to the rear of or around its spindle for securing a drill bit.

The drill may comprise, to the rear of or around the spindle, a ring 410, as shown in FIG. 24, which rotates as one with the spindle. This ring 410 comprises, at its periphery, at least one orifice or recess 412 in which a projecting element of a removable grip, such as that illustrated in FIG. 23, is designed to be engaged. This projecting element may be a tooth 414 extending substantially radially inward (in the direction of the axis B) from the internal periphery of the second part 400b of the grip, as shown in broken lines. The interaction by engagement of the tooth 414 of the grip in the orifice 412 of the ring 410 of the drill may fulfill an indexing function of the grip and/or an anti-rotation function. In this latter case, it enables a user to oppose the torque transmitted during immobilization of the spindle during drilling. It should, however, be noted that, in the absence of interaction between one more teeth of the grip and one or more orifices of the ring, the friction forces between the grip and the ring could suffice to fulfill the anti-rotation function.

In the preceding embodiments, the tool may comprise a set of position sensors so that the quantity of resin injected can be calculated and withdrawal of the tool thus adapted (a position sensor or an injection speed sensor makes it possible to obtain an injected or metered resin quantity, and a position sensor or bearing rod speed sensor makes it possible to determine a withdrawal distance).

With the pneumatic sequential solution mentioned above, it is possible merely to inject a metered amount of resin (a volume). Withdrawal takes place after such injection by a distance that is proportional to this metered amount and dependent on the diameter of the hole into which the nozzle is inserted. There is no longer any need for a sensor since it is possible to base a decision on “metered amounts” and as a result to adapt the course of travel of the metering or injection actuator.

The first table below illustrates an example in which the metered amount of resin injected is fixed and the withdrawal course of travel of the tool is made to vary. The first column comprises the diameter of the hole, the second column comprises the distance of movement of the resin injection command actuator (“injection course of travel”), the third column comprises the distance of movement of the bearing rod (“metering or tool withdrawal course of travel”), and the last column comprises the ratio of the cross-sectional area of the resin cartridge to the cross-sectional area of the hole. These cross-sections are taken perpendicular to the longitudinal axes of the resin cartridge and the hole. The ratio of metering course of travel to the injection course of travel is substantially equal to the ratio of the cross-sectional area of the resin cartridge to the cross-sectional area of the hole in this embodiment.

| Hole diameter | Injection course | Metering course | |
|---|---|---|---|
| (mm) | of travel (mm) | of travel (mm) | Relationship |
| 15 | 1.7 | 25.4 | 15 |
| 18 | 1.7 | 17.7 | 10.4 |
| 20 | 1.7 | 14.3 | 8.4 |
| 25 | 1.7 | 9.2 | 5.4 |
| 32 | 1.7 | 5.6 | 3.3 |
| 35 | 1.7 | 4.7 | 2.7 |
| 40 | 1.7 | 3.6 | 2.1 |

The second table below illustrates an example in which the metering course of travel is fixed and the metered amount injected is made to vary.

| Hole diameter | Injection course | Metering course | |
|---|---|---|---|
| (mm) | of travel (mm) | of travel (mm) | Relationship |
| 15 | 2 | 30 | 15 |
| 18 | 2.9 | 30 | 10.4 |
| 20 | 3.6 | 30 | 8.4 |
| 25 | 5.6 | 30 | 5.4 |
| 32 | 9.1 | 30 | 3.3 |
| 35 | 10.9 | 30 | 2.7 |
| 40 | 14.3 | 30 | 2.1 |

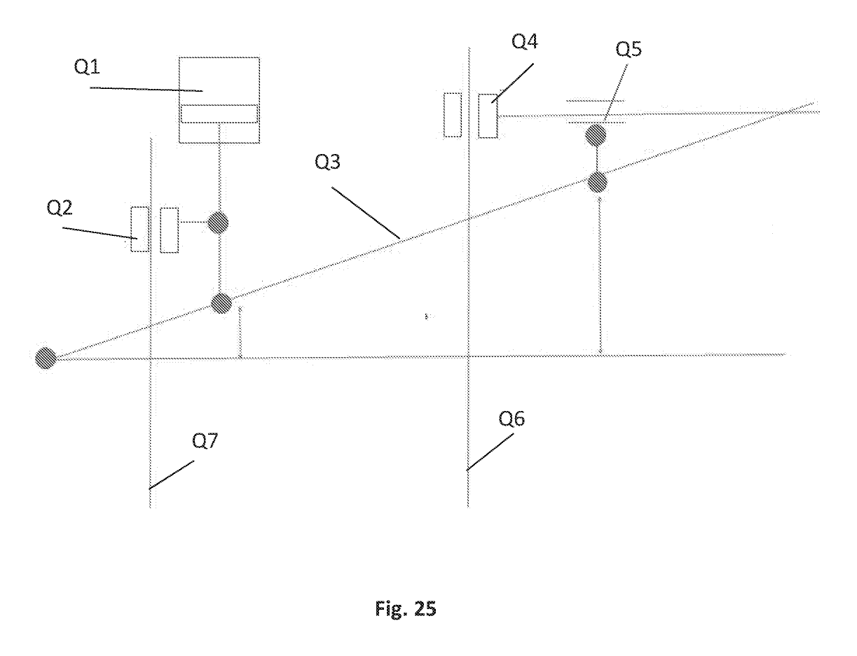

A physical link between the metering course of travel and the injection course of travel could even be envisaged. As schematically illustrated in FIG. 25, a single pneumatic actuator Q1 could actuate the metering and injection advance movements, and the lever arms would then be adjusted in order to achieve the correct volume/metering ratio.

In the operating principle, a pneumatic distributor could be used to perform a “square” loop cycle between injection and metering. When injection ends, the distributor would swap pressure to the piston, which would carry out a metering operation, and so on. There would then be only the pneumatic logic component, and no longer any control electronics.

In the example of FIG. 25, the piston rod of the pneumatic actuator Q1 is connected, for example via a braced forward movement system Q2, to the metering piston in order to command injection of resin in accordance with a specific course of travel Q7. The piston rod of the actuator Q1 is furthermore connected via a pivoting lever Q3 to a braced forward movement system Q4 in order to command the movement of the bearing rod Q6 over a given course of travel. The latter is dependent on the aforesaid lever effect and, in particular, on the position of the link Q5 of the lever Q3 to the system Q4. The link Q5 can, here, move along the lever Q3 in order to allow adjustment of the lever arm applying to the bearing rod Q6.

The end of this cycle would determine the quantity of resin that would be injected. There would, for example, be a pneumatic end of travel device that would detect the end of the bearing rod or a shape irregularity on this rod. After a certain metering distance, the end of travel device would be actuated and would cut off the pneumatic cycle. To that end, the bearing rod could be associated with an end of travel mechanisms that would be able to move relative to the rod and moved by an operator, in particular as a function of the depth of the hole that could be achieved via the method described above. If the hole were too deep relative to a nominal position, this excess depth could easily be detected by the supplementary movement distance of the piston rod relative to the position it would occupy in the case of a hole of nominal depth.

On account of this operating principle, the bearing rod may be “reinitialized” for each new hole. In effect, when a new hole is being cleaned at the beginning of a cycle, the bearing rod is pushed back by a length equal to the depth of the hole. Given that the metering end of travel device is installed to the rear of the bearing rod, if the hole is deeper than the nominal hole the metered amount injected will be greater. If the hole is more shallow, the metered amount injected is reduced. This constitutes automatic adjustment of the metered amount, which is particularly advantageous.

In various embodiments, a nozzle for a tool for injecting chemical anchor resin into a hole in a wall includes a body defining an internal resin passage duct, the body also having one end connectable to one of: the tool and at least one cartridge of the tool, wherein the nozzle is configured to clean the hole via at least one of: brushing and gas injection.

In one such embodiment, the body further defines an internal gas passage duct.

In another such embodiment, the internal gas passage duct is oriented along a longitudinal axis of the body.

In another such embodiment, the body defines two resin passage ducts flanking the longitudinal axis of the body.

In another such embodiment, the body defines two external longitudinal grooves flanking the longitudinal axis of the body.

In another such embodiment, the body includes a free end, and the nozzle includes an end fitting attached to the free end of the body, the end fitting defining: (1) an air ejection orifice in fluidic communication with the internal gas passage duct, and (2) a resin ejection orifice in fluidic communication with the internal resin passage duct.

In another such embodiment, the nozzle includes a brush configured to brush an internal surface of the hole.

In another such embodiment, the brush includes two independent external brushes.

In another such embodiment, the brushes are attached to the body such that the brushes are diametrically opposed to one another with respect to a longitudinal axis of the body.

In another such embodiment, the brushes are respectively mounted in longitudinal grooves defined in the body.

In another embodiment, the nozzle is rotatable.

In various embodiments, a tool for injecting chemical anchor resin into a hole in a wall includes a nozzle having a body defining an internal resin passage duct and an internal gas passage duct and a resin injection assembly configured to manipulate at least one cartridge, when installed, to cause resin to flow from the at least one cartridge into the internal resin passage duct.

In one such embodiment, the tool includes a rotary mixer fixedly connected to the body of the nozzle.

In another such embodiment, the rotary mixer defines a bore in fluidic communication with the internal gas passage duct of the body of the nozzle.

In another such embodiment, the tool includes a motor and a drive member operably connected to an output shaft of the motor, the drive member defining a bore, the rotary mixer connected to the drive member such that the bore of the rotary mixer is in fluidic communication with the bore of the drive member.

In another such embodiment, the drive member defines an external annular groove in fluidic communication with the bore of the drive member, the drive member being at least partially surrounded by a stator bushing that closes the groove and that comprises at least one substantially radial orifice opening into the groove and configured to be connected to an air outlet of a compressor incorporated into the tool.

In another such embodiment, the tool is configured to be connected to a pneumatic air supply.

In various embodiments, a method for injecting chemical anchor resin into a hole in a wall using a single tool equipped with a nozzle includes: (1) inserting the nozzle into the hole, (2) injecting air into the hole using the nozzle or rotating the nozzle so as to use the nozzle to brush at least one internal surface of the hole, and (3) injecting resin into the hole using the nozzle.

In one such embodiment, at least two of the steps are carried out simultaneously or sequentially.

In another such embodiment, the method includes controlling the progressive introduction of the nozzle into the hole or the progressive withdrawal of the nozzle from the hole via a linear actuator bearing against the wall.

In another such embodiment, the method includes rotating the nozzle during step (2).

In another such embodiment, the method includes: (a) inserting the nozzle into the hole until the nozzle bears against a bottom of the hole, (b) detecting the position of a linear actuator of the tool, and (c) calculating a depth of the hole based in part on the detected position.

In another such embodiment, the method includes determining a quantity of resin to be injected based in part on the depth of the hole, the tool parameters being set to inject this quantity of resin during the injection step.

1-22. (canceled)

23: A chemical anchor resin injecting tool nozzle comprising:
a body defining an internal resin passage duct, the body having one end connectable to one of: chemical anchor resin injecting tool and at least one cartridge of the chemical anchor resin injecting tool,
at least one of a brush and a gas injection mechanism, and configured to clean the hole via at least one of: brushing and gas injection.

24: The chemical anchor resin injecting tool nozzle of claim 23, wherein the body defines an internal gas passage duct.

25: The chemical anchor resin injecting tool nozzle of claim 24, wherein the internal gas passage duct is oriented along a longitudinal axis of the body.

26: The chemical anchor resin injecting tool nozzle of claim 25, wherein the body defines two resin passage ducts flanking the longitudinal axis of the body.

27: The chemical anchor resin injecting tool nozzle of claim 25, wherein the body defines two external longitudinal grooves flanking the longitudinal axis of the body.

28: The chemical anchor resin injecting tool nozzle of claim 23, wherein the body includes a free end, and which includes an end fitting attached to the free end of the body, the end fitting defining: (a) an air ejection orifice in fluidic communication with the internal gas passage duct, and (b) a resin ejection orifice in fluidic communication with the internal resin passage duct.

29: The chemical anchor resin injecting tool nozzle of claim 23, wherein the brush includes two independent external brushes.

30: The chemical anchor resin injecting tool nozzle of claim 29, wherein the external brushes are attached to the body such that the brushes are diametrically opposed to one another with respect to a longitudinal axis of the body.

31: The chemical anchor resin injecting tool nozzle of claim 29, wherein the external brushes are respectively mounted in longitudinal grooves defined in the body.

32: The chemical anchor resin injecting tool nozzle of claim 23, which is rotatable.

33: A chemical anchor resin injecting tool for injecting chemical anchor resin into a hole in a wall, the chemical anchor resin injecting tool comprising:
a nozzle having a body defining an internal resin passage duct and an internal gas passage duct; and
a resin injection assembly configured to manipulate at least one cartridge, when installed, to cause resin to flow from the at least one cartridge into the internal resin passage duct.

34: The chemical anchor resin injecting tool of claim 33, which includes a rotary mixer fixedly connected to the body of the nozzle.

35: The chemical anchor resin injecting tool of claim 34, wherein the rotary mixer defines a bore in fluidic communication with the internal gas passage duct of the body of the nozzle.

36: The chemical anchor resin injecting tool of claim 34, which includes a motor and a drive member operably connected to an output shaft of the motor, the drive member defining a bore, the rotary mixer connected to the drive member such that the bore of the rotary mixer is in fluidic communication with the bore of the drive member.

37: The chemical anchor resin injecting tool of claim 36, which includes a compressor, and wherein the drive member defines an external annular groove in fluidic communication with the bore of the drive member, the drive member being at least partially surrounded by a stator bushing that closes the groove and that includes at least one substantially radial orifice opening into the groove and configured to be connected to an air outlet of the compressor.

38: The chemical anchor resin injecting tool of claim 33, which is configured to be connected to a pneumatic air supply.

39: A method for injecting chemical anchor resin into a hole in a wall using a single tool equipped with a nozzle, the method comprising:
(a) inserting the nozzle into the hole;
(b) injecting air into the hole using the nozzle or rotating the nozzle so as to use the nozzle to brush at least one internal surface of the hole; and
(c) injecting resin into the hole using the nozzle.

40: The method of claim 39, wherein at least two of steps (a), (b), and (c) are carried out simultaneously.

41: The method of claim 39, wherein at least two of steps (a), (b), and (c) are carried out sequentially.

42: The method of claim 39, which includes controlling the progressive introduction of the nozzle into the hole or the progressive withdrawal of the nozzle from the hole via a linear actuator bearing against the wall.

43: The method of claim 39, which includes rotating the nozzle during step (b).

44: The method of claim 39, which includes: (i) inserting the nozzle into the hole until the nozzle bears against a bottom of the hole, (ii) detecting the position of a linear actuator of the tool, and (iii) calculating a depth of the hole based in part on the detected position.

45: The method of claim 44, which includes determining a quantity of resin to be injected based in part on the depth of the hole, the tool parameters being set to inject this quantity of resin during the injection step.
